(19) United States
(12) Patent Application Publication
(10) Pub. No.: US 2016/0281627 A1
(43) Pub. Date: Sep. 29, 2016

(54) Method and Device for Testing a Fuel Pressure System, Comprising a Fuel Pressure Sensor, of a Combustion Controlled Internal Combustion Engine of a Motor Vehicle

(71) Applicant: Mercedestrasse 137, Stuttgart (DE)

(72) Inventor: Joerg MOELLER, Leutenbach (DE)

(73) Assignee: DAIMLER AG, Stuttgart (DE)

(21) Appl. No.: 15/036,661

(22) PCT Filed: Nov. 13, 2014
(86) PCT No.: PCT/EP2014/003042

§ 371 Date: May 13, 2016

(30) Foreign Application Priority Data
Nov. 15, 2013 (DE) 102013019068.1

(51) Int. Cl. F02D 41/22

(52) U.S. Cl. CPC F02D 41/222; F02D 2041/223

(57) ABSTRACT

A method for testing and/or correcting a fuel pressure sensor provided for detecting a fuel pressure in a combustion controlled internal combustion engine of a motor vehicle is disclosed. In at least one test run, the fuel pressure is changed from a working pressure value to a test pressure value when the combustion control is active. After the change of the fuel pressure a desired fuel injection duration and an actual fuel injection duration are compared with one another. An internal combustion engine device for carrying out the method is also disclosed.

### BACKGROUND AND SUMMARY OF THE INVENTION

A method for checking a fuel pressure sensor provided for detecting a fuel pressure in an internal combustion engine of a motor vehicle is known from DE 197 21 176 A1, wherein the fuel pressure is changed from a working pressure value to a test pressure value while a lambda control is active.

The object of the invention is to provide an improved method of testing which is particularly suitable for testing the fuel pressure sensor particularly reliably.

The invention relates to a method and device for testing a fuel pressure system, including a fuel pressure sensor, of a combustion controlled internal combustion engine of a motor vehicle. In the method, in at least one test run the fuel pressure is changed from a working pressure value to a test pressure value when the combustion control is in operation. In this case an initial measured value of a measurement variable dependent upon the working pressure is detected and associated with the working pressure value. After the change of the fuel pressure to the test pressure an actual value of the measurement variable dependent upon the working pressure is detected.

The combustion control can be performed, for example, by a lambda control, combustion chamber pressure control, combustion progress control, speed control or torque control. The engine may be a diesel engine, a gasoline engine, a gas engine or the like.

It is proposed that a desired value is associated with the measurement variable. In this case the desired value can be, for example, stored in a table from which a characteristic field can be taken or calculated. The desired value, the actual value and the initial measured value are set in relation to one another by converting them into percentage values, wherein a percentage value of 100 is associated with the initial measured value. The desired value is preferably already stored as a percentage value. In this case conversion of the desired value can be omitted. Then the percentage values for the desired value and the actual value are compared with one another and a fault is identified if the percentage value for the actual value deviates from the percentage value for the desired value beyond a definable tolerance. Examples of suitable measurement variables are the fuel injection duration, the delivered fuel mass, and the delivered volume of fuel. The following statements concerning the parameter of the fuel injection duration are transferable by analogy to other suitable measurement variables such as fuel mass, fuel volume and the like. Any reference below to the fuel injection duration should be understood to be by way of example.

In an embodiment the initial measured value is formed as an initial fuel injection duration, the actual value is formed as an actual fuel injection duration and the desired value is formed as a desired fuel injection duration.

A “fuel injection duration” should in particular be understood to be a time during which fuel is delivered at least to a combustion chamber. The fuel injection duration preferably corresponds at least to an opening duration and/or a control duration at least of a fuel injector during of a working cycle of a cylinder. In this case the fuel delivery can take place for example during an intake phase, during a compression phase or also over an entire cycle. If a plurality of injections are provided during a working cycle of a cylinder, for example in the form of pre-injection, main injection and/or post-injection, then for example the sum or the average value of these injections in a working cycle of a cylinder can be used as a basis for the calculations. The designation “fuel injection duration” should not imply that the fuel delivery must be designed as a direct injection, but any type of fuel delivery should be subsumed under this designation in the following description.

Since the fuel injection duration is dependent upon the fuel pressure, it is suitable for testing the fuel pressure sensor for fault-free functioning. On the basis of a non-linear correlation between the fuel pressure and the fuel injection duration, a defect of the fuel pressure sensor causes an unexpected change in the fuel pressure, so that a defect of the fuel pressure sensor can be reliably identified by the change in the fuel pressure. Because a defective fuel pressure sensor causes a difference between an expected desired test pressure and an effective actual test pressure, the expected desired fuel injection duration and the actual fuel injection duration differ from one another. The difference between the expected desired fuel injection duration and the effective actual fuel injection duration can be brought into a direct correlation with the defect of the fuel pressure sensor, so that a fast and secure testing of the fuel pressure sensor can be implemented. In this way the fuel pressure sensor can be tested particularly reliably, so that current and/or future statutory requirements, in particular requirements relating to environmental protection, can be met. The method for testing is preferably used for on-board diagnosis of the fuel pressure sensor.

A “working pressure value” should in particular be understood to be a value of the fuel pressure which is present and/or set during operation, preferably customer operation, of the internal combustion engine before a start of the test run or during the test run, but before the change in the fuel pressure. The working pressure value is preferably reset after the method or after the test run.

A “test pressure value” should in particular be understood to be a value of the fuel pressure which differs from the working pressure value and is advantageously present during operation, preferably customer operation, of the internal combustion engine after the change in the fuel pressure or is set by the change in the fuel pressure.

“After the change in the fuel pressure” should be understood in particular to be at the present and/or regulated test pressure value. The test pressure value is preferably set merely for the purpose of testing the fuel pressure sensor.

In an embodiment the active combustion control can be designed as an active lambda control, in which combustion of a fuel/air mixture is adjusted with the aid of a lambda sensor to a specific lambda value. Due to the active combustion control, in particular active lambda control, a known or fixed ratio preferably exists in each engine operating point between a drawn-in air mass in a combustion chamber and an injected fuel mass in the combustion chamber, so that the fuel mass which is required for providing the specific lambda value can be determined by the drawn-in air mass. The fuel mass is advantageously dependent upon the fuel pressure and the fuel injection duration, so that at the known or assumed fuel pressure the fuel injection duration can be determined and at the known or assumed fuel injection duration the fuel pressure can be determined.

The test pressure value is preferably deemed to be regulated if the value of the variable to be controlled by the combustion control (lambda, combustion chamber pressure or the like) at the test pressure value deviates by a maximum of 3%, advantageously by a maximum of 2% and particularly advantageously by a maximum of 1% from its value at the working pressure value.

A “desired fuel injection duration” should be understood to be a fuel injection duration expected after the change of the fuel pressure. An “actual fuel injection duration” should be understood to be an effective actual fuel injection duration after the change of the fuel pressure.

Furthermore, in an embodiment it is proposed that the desired fuel injection duration and the actual fuel injection duration are determined in the test run, so that the method can be carried out in the customer operation of the internal combustion engine. As a result it is possible to dispense with a determination of the desired fuel injection duration during a production phase of the internal combustion engine and/or of a motor vehicle including the internal combustion engine, so that production of the internal combustion engine and/or of the motor vehicle and thus a transfer to a customer can be speeded up.

Furthermore, in order to provide the desired fuel injection duration it is proposed that the desired fuel injection duration is determined as a function of the fuel pressure detected by the fuel pressure sensor, so that a fuel injection duration which is expected on the basis of the fuel pressure measured with the aid of the fuel pressure sensor to be tested can be used advantageously for testing of the fuel pressure sensor. After the change of the fuel pressure, the desired fuel injection duration is advantageously determined by means of the fuel pressure measured by the fuel pressure sensor and by the fuel mass which is predetermined by the active combustion control and/or is dependent upon the air mass drawn in. The desired fuel injection duration is preferably designed as a fuel injection duration which would be expected in principle on the basis of the change of the fuel pressure measured with the aid of the fuel pressure sensor, in order to inject the fuel mass required for the specific lambda value.

In order to provide the actual fuel injection duration it is in particular advantageous if the actual fuel injection duration is determined as a function of the lambda control, so that an effective actual fuel injection duration which is necessary for setting the specific lambda value can be used advantageously for testing of the fuel pressure sensor. The actual fuel injection duration is preferably set or predetermined by the lambda control reacting to the change of the fuel pressure, in order to maintain and/or to set the specific lambda value. The actual fuel injection duration is preferably designed as a fuel injection duration which is set by the lambda control, in particular when the lambda value differs from a required lambda value. If the desired fuel injection duration and the actual fuel injection duration differ from one another, it preferably follows from this that the fuel pressure measured by the fuel sensor differs from an effective fuel pressure, since the fuel injection duration changes with the fuel pressure at a constant required fuel mass.

Alternatively, instead of the control described here with the aid of a lambda sensor it is also possible to use any other form of combustion control. In this case lambda values are, for example, replaced by combustion progress values or combustion chamber pressure values.

A “load” should be understood to be an operational state of the internal combustion engine. In this case “full load” designates an operational state in which the maximum possible torque is provided. If the internal combustion engine produces a lower torque by throttling the supply of energy, this is designated as a partial load. The load of the internal combustion engine is also referred to below as the engine load.

Furthermore it is advantageous if the desired fuel injection duration and the actual fuel injection duration are determined as a function of an applied load, so that the test run during the operation of the internal combustion engine can preferably be carried out at each operating point: The desired fuel injection duration and the actual fuel injection duration are dependent upon values set and/or present currently in operation, in particular in customer operation, of the internal combustion engine. The method or at least the test run is usually carried out during an ignition operation. However, the method according to the invention can also be carried out during the driving operation and even in the event of a changing load. This has the advantage that typical measurement points of the driving operation can be examined and also a plurality of different measurement points can be examined. As a result an offset, a gradient error and even the shape of the real current sensor curve of the tested sensor and the real values of the system can be determined and optionally corrected or set.

Furthermore it is advantageous if an initial fuel injection duration is determined for comparison of the desired fuel injection duration and the actual fuel injection duration before the change of the fuel pressure, wherein after the change of the fuel pressure a percentage desired difference between the initial fuel injection duration and the desired fuel injection duration and a percentage actual difference between the initial fuel injection duration and the actual fuel injection duration are compared with one another, so that the test run can be carried out independently of the prevailing working pressure. Thus a dependence of the difference between the desired fuel injection duration and the actual fuel injection duration upon the applied load can be eliminated, so that load-independent checking of the fuel pressure sensor can be implemented. Thus the test run can be carried out with any amounts of injected fuel. The initial fuel injection duration is preferably determined in the test run. The initial fuel injection duration is advantageously dependent upon values set and/or present currently in operation, in particular in customer operation, of the internal combustion engine. “Before the change of the fuel pressure” should be understood in particular to mean at the present and/or regulated working pressure.

In a particularly advantageous configuration the determination of the deviation of the fuel injection duration takes place independently of the load. For this purpose the actual fuel injection duration designated as the initial fuel injection duration is set to 100% before the pressure jump (for example: 0.4 ms=100%). The actual fuel injection duration after the pressure jump is set in relationship with this (for example: 0.68 ms=170%). The actual fuel injection duration is increased by 70% by the pressure jump. Moreover, based on the actual fuel injection duration before the pressure jump and the magnitude of the pressure jump, the expected desired fuel injection duration is calculated after the pressure jump. For example, based on an initial fuel injection duration before the pressure jump of 0.4 ms, with the same pressure jump a rise in the fuel injection duration from 0.4 ms to 0.6 ms (from 100% to 150%), that is to say by only 50%, is to be expected. Through the percentage comparison of the desired fuel injection duration after the pressure jump with the actual fuel injection duration after the pressure jump, the deviation of the fuel injection duration of 20% here is merely dependent upon the change of the fuel pressure due to the pressure jump. The value calculated in this way is only dependent upon the magnitude of the pressure jump and upon the pressure level to be tested at which it is carried out (through flow cross-section A=constant, raw=constant). Since the pressure jump and the deviation of the fuel injection duration after the pressure jump are known, a conclusion can be drawn as to the real actual pressure level before the pressure jump.

In a simplified variant, a characteristic value, a characteristic curve or a characteristic field is stored with the percentage values for the expected desired difference in the engine control unit. Since the load no longer has any influence in the percentage comparison of the actual fuel injection duration after the pressure jump to the desired fuel injection duration after the pressure jump, a calculation of the desired difference can be omitted.

In particular it is advantageous if in at least a further test run the fuel pressure is set to a further test pressure value, so that in addition to an offset error a gradient error of the fuel pressure sensor can also be identified. The offset error of the fuel pressure sensor can preferably be identified after a single test run. A “further test run” should be understood in particular to be a subsequent second test run which is started and/or carried out after a preceding first test run is carried out. The further test pressure value preferably differs from the working pressure value and the test pressure value which is set in the preceding first test pressure value. In this case the further test pressure value is preferably set based on the working pressure value or based on the first test pressure value which is set in the preceding first test pressure step.

In an embodiment at least two test runs are carried out at the same working pressure value and the same pressure jump to a test pressure value.

In an embodiment at least two test runs are carried out at a different working pressure value.

In an embodiment at least two test runs are carried out with a different test pressure value.

In an embodiment at least two test runs are carried out with a different pressure jump direction. In an embodiment load changes are detected during the test run, and then the test pressure value is corrected by its load change-related proportion and/or the desired value and the actual value are corrected by their load change-related proportion. In this way a test run can also be evaluated when a load change takes place during the test run.

In a particularly favorable embodiment, already during the pressure change of the test run at least one actual value is recorded and is set in relationship in percentage terms with the initial measured value as a percentage, a percentage value for the associated desired value is determined and is compared with the percentage value for the actual value and a fault is identified if the percentage value for the actual value deviates from the percentage value for the desired value by a definable tolerance. In this case the debounce time is omitted. Thus, already during the pressure jump, it is possible in the range of the rise from initial measured value 17 to actual value 16 of the curve 45 or the rise from initial measured value 17 to desired value 15 of the curve 46 in FIG. 4, to record one or more actual values and to check each one for deviation from its desired value. Accordingly, for these measurements the values for the desired difference 18, the actual difference 19 and the deviation 20 lie in this range of the pressure change. For the measurement in the range of the pressure rise, tolerances can preferably be defined which are dependent upon the magnitude of the pressure rise occurring up to the time of the measurement. For example, every 10 ms or 100 ms an actual value can be determined and compared with its desired value. In this way virtually continuous testing can be carried out over the entire range of the pressure rise. As a result a fault can be identified more quickly. In the event of a considerable deviation a fault can already be determined, for example, 10 ms after the start of the test run, even before the definitive test pressure value of the pressure jump has been reached. Therefore, moreover, the fault can be detected more precisely by testing over an entire pressure range; it is possible to identify how the pressure profile determined by the pressure sensor deviates from the real pressure profile. Thus the deviation of the characteristic curve of the pressure sensor from its desired course can be identified and thereafter can also be corrected. Thus not only a gradient error or an offset even a non-linear error curve or fluctuations of the measurement error dependent upon the pressure range can be identified and, if need be, can then be corrected.

In an embodiment, in the event of a determination of values cylinder by cylinder, a fault is only identified as a sensor fault when the fault is present irrespective of the cylinder, and otherwise the fault is identified as associated with an individual cylinder.

In addition or alternatively, in an embodiment, in the event of a determination of values bank by bank, a fault is only identified as a sensor fault if the fault is present on both banks, and otherwise the fault is identified as a system fault.

In an advantageous embodiment, when a fault is identified by the test run, in at least one correction run the fuel pressure sensor is corrected according to a deviation between the desired fuel injection duration and the actual fuel injection duration. In this way the setting of the fuel pressure sensor can be corrected cost-effectively.

In order to avoid changes of load during the test run, it is advantageous if at least the test run takes place during a constant load. This enables a particularly precise determination of the desired fuel injection duration and the actual fuel injection duration. A “constant load” should in particular be understood to be an engine load which changes during the test run by a maximum of 8%, advantageously by a maximum of 5% and particularly advantageously by a maximum of 3%, wherein the load at the start of the test run defines a basic value or a starting value. Preferably at least the drawn-in air mass, and thus the required injected fuel mass, remains at least substantially constant during a constant load. In this connection “at least substantially” should be understood in particular to mean a deviation of a drawn-in air mass present at the start of the test run, and thus an injected fuel mass, of a maximum of 3%, advantageously of a maximum of 2% and particularly advantageously of a maximum of 1%. A constant load prevails for example during idling and driving with cruise control. In a preferred embodiment the test run is carried out in an operational state of the internal combustion engine in which the load is constant, such as for example during idling or driving with cruise control. In this case the test run preferably lasts for a few seconds. The test run advantageously lasts less than ten seconds, particularly advantageously less than 7 seconds and especially advantageously less than five seconds.

In an embodiment the change of the engine load is monitored and the test process is interrupted if during the test process the load deviates beyond a definable tolerance from the starting value.

In an embodiment the change of the engine load is recorded and compensated. This can be achieved by determining the load change during the test run and the influence thereof on the actual fuel injection duration and optionally the desired fuel injection duration is offset. The more the load at the end of the test cycle differs from the load at the beginning of the test cycle, the more the percentage change of the fuel injection duration is corrected. However, a change of the drawn-in air mass/amount or also a changed lambda value can be regarded as a measure of the influence of the load.

Furthermore, a device for a combustion controlled internal combustion engine of a motor vehicle, in particular for carrying out a method according to the invention, is proposed. This has a fuel pressure sensor provided for recording a fuel pressure and a control and/or regulating unit provided for testing a fuel pressure sensor, by means of which unit in at least one test run the fuel pressure can be changed from a working pressure value to a test pressure value whilst a combustion control is active.

The device is characterized in that the control and/or regulating unit is provided in order, after the change of the fuel pressure, to compare a percentage value for a desired value and a percentage value for an actual value and to identify a fault if the percentage value for the actual value deviates from the percentage value for the desired value beyond a determinable tolerance.

As a result the internal combustion engine can be controlled and/or regulated particularly reliably, so that a particularly low-consumption internal combustion engine can be provided which has a low pollutant emission.

Further advantages can be seen from the following description of the figures. An exemplary embodiment of the invention is shown in the drawings. The figures, the description of the figures and the claims contain numerous characteristics in combination. Expediently, the person skilled in the art will also consider the features singly and combine them to form meaningful further combinations.

### BRIEF DESCRIPTION OF THE DRAWINGS

FIG. 1 shows schematically an internal combustion engine apparatus which has a fuel pressure sensor and a control and regulating unit for testing the fuel pressure sensor,

FIG. 2 shows a flow diagram of a method in which the fuel pressure sensor is tested and corrected,

FIG. 3 shows an example of a fuel pressure curve during a change of the fuel pressure for testing the fuel pressure sensor, and

FIG. 4 shows an example of a fuel injection duration curve during the change of the fuel pressure according to FIG. 3.

### DETAILED DESCRIPTION OF THE DRAWINGS

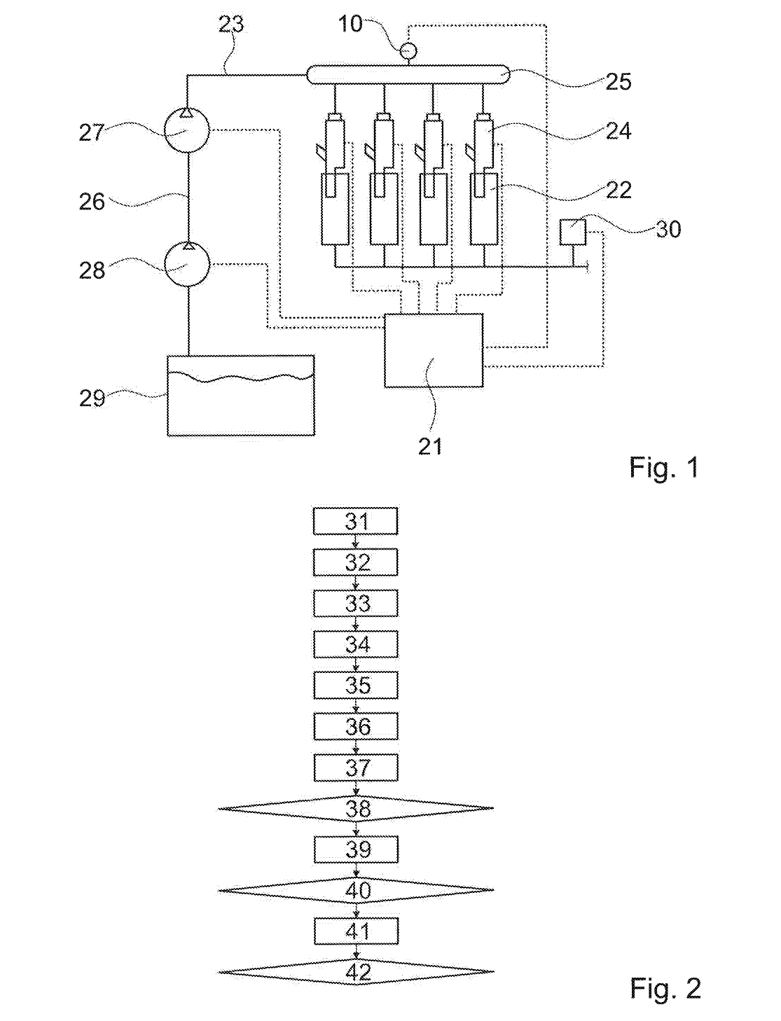

FIG. 1 shows an embodiment of an internal combustion engine apparatus for a motor vehicle which has an internal combustion engine which is controlled by a combustion control and can be operated homogeneously or inhomogeneously. The internal combustion engine has one or more cylinders 22 which each have a combustion chamber in which a fuel/air mixture is burned in operation of the internal combustion engine. In order to supply the combustion chambers with a fuel the internal combustion engine apparatus has a high pressure system 23. The high pressure system 23 in the illustrated embodiment comprises one or more electrically controlled fuel injectors 24 which are each associated with a cylinder 22. In each case at least one fuel injector 24 is provided in order to deliver the fuel to a combustion chamber. In this exemplary embodiment the fuel is in the form of petrol. The high pressure system 23 is therefore typically provided for fuel pressures from approximately 20 to 300 bars. During operation of the internal combustion engine a fuel pressure of approximately 150 to 300 bars prevails in the high pressure system 23. The internal combustion engine is designed as a petrol engine. In principle the fuel can also be diesel or another liquid or gaseous fuel and thus the internal combustion engine can be designed as a diesel engine, gas engine or the like. In this case the high pressure system for the diesel engine is typically provided for fuel pressures of approximately 1500 to 2000 bars.

In order to provide the fuel for the fuel injectors 24 the high pressure system 23 has a distributor pipe 25 (rail). The distributor pipe 25 is designed as a common distributor pipe and thus is simultaneously linked fluidically to all fuel injectors 24. The distributor pipe 25 is designed as a high pressure store for the fuel. The distributor pipe 25 supplies all fuel injectors 24 with one and the same fuel pressure. In order to provide the fuel for the high pressure system 23 the internal combustion engine apparatus has a low pressure system 26. The low pressure 26 is arranged fluidically before the high pressure system 23.

For supplying the high pressure system 23 with the fuel from the low pressure system 26 the internal combustion engine apparatus has a high pressure pump 27. It sets a fuel pressure in the high pressure system 23 and thus in the distributor pipe 25. The high pressure pump 27 conveys the fuel from the low pressure system 26 into the high pressure system 23.

The internal combustion engine apparatus has a low pressure pump 28 for supplying the low pressure system 26 with the fuel. It sets a fuel pressure in the low pressure system 26 which is much lower than the fuel pressure in high pressure system 23. During operation of the internal combustion engine a fuel pressure below 10 bars prevails in the low pressure system 26. The low pressure pump 28 supplies the low pressure system 26 with the fuel from a fuel tank 29 of the motor vehicle in which the fuel is stored. It conveys the fuel from the fuel tank 29 into the low pressure system 26.

For detecting the fuel pressure in the high pressure system 23 the internal combustion engine apparatus has a fuel pressure sensor 10. The fuel pressure sensor 10 measures the fuel pressure in the distributor pipe 25. It measures the fuel pressure between the high pressure pump 27 and the fuel injectors 24. The fuel pressure sensor 10 registers the fuel pressure with which the fuel injectors 24 are supplied and thus with which the fuel is injected into the combustion chambers.

In order to control the combustion in the combustion chambers, in the illustrated embodiment the internal combustion engine apparatus has a lambda sensor 30 which is provided for lambda control. For this purpose the lambda control adjusts an air mass and a fuel mass in the combustion chambers to a specific ratio by comparison with a stoichiometric mixture. In this case the ratio is dependent upon a desired lambda value. The lambda control adjusts the desired lambda value in an exhaust gas of the internal combustion engine. In this exemplary embodiment the lambda value is 1, so that a stoichiometric fuel ratio is set. In the stoichiometric fuel ratio includes precisely the air mass which is theoretically required in order to completely burn the fuel. In this exemplary embodiment the ratio of air to fuel is 14.7 to 1. Thus in an active lambda control this is at least a substantially constant ratio between the drawn-in air mass in the combustion chamber and the injected fuel mass in the combustion chamber. Thus the fuel mass is connected by means of the lambda control to the air mass. For measurement of the drawn-in air mass the internal combustion engine apparatus has an air mass measuring device (not shown), so that with active lambda control the required fuel mass which is necessary for setting the required lambda value can be determined.

The lambda sensor 30 is provided for detection of the lambda value present. The lambda sensor 30 measures a residual oxygen content in the exhaust gas which is drawn off from the combustion chambers after the combustion of the fuel/air mixture. The lambda control determines the fuel/air ratio of the past combustion from the measured lambda value. Depending upon the measured lambda value the lambda control adjusts the combustion zone to the desired lambda value, in that in the illustrated exemplary embodiment, for example, it correspondingly changes a fuel injection duration, that is to say a time during which the fuel is delivered, in particular injected in the illustrated exemplary embodiment. In this case the fuel injection duration is dependent upon the required fuel mass and the fuel pressure with which the fuel injectors 24 are supplied.

For control and regulation the internal combustion engine apparatus has a control and regulating unit 21 designed as an engine control unit. It controls or regulates the fuel injectors 24, the high pressure pump 27 and the low pressure pump 28. The control and regulating unit 21 adjusts the fuel injection duration by controlling the fuel injectors 24, adjusts the fuel pressure in the high pressure system 23 by controlling the high pressure pump 27, and adjusts the fuel pressure in the low pressure system 26 by controlling the low pressure pump 28. In this case the control and regulating unit 21 takes into account a plurality of values currently occurring in operation, such as for example engine speed, accelerator pedal position and/or the like. In principle the control and regulating unit 21 also controls and regulates further units.

The control and regulating unit 21 is further connected to the air mass measuring device, the fuel pressure sensor 10 and the lambda sensor 30. It communicates with the air mass measuring device, the fuel pressure sensor 10 and the lambda sensor 30, so that the air mass flow measured by the air mass measuring device, the fuel pressure measured by the fuel pressure sensor 10, and the residual oxygen content measured by the lambda sensor 30, are available to the control and regulating unit 21. In principle the control and regulating unit 21 can be connected to further sensors, so that the control and regulating unit 21 can take account of further values, such as for example a fuel temperature, a fuel density, an ethanol content in the fuel and/or the like.

In order to ensure optimal control of the combustion, the control and regulating unit 21 tests the fuel pressure sensor 10 for its precision and function and corrects it if a fault is identified. To this end a method for testing the fuel pressure sensor 10 is implemented in the control and regulating unit 21. This method is described in greater detail below, wherein the procedure of the method is illustrated by a flow diagram in FIG. 2.

The method for testing the fuel pressure sensor 10 is preferably started automatically in each ignition operation. Alternatively the method can also be started when other conditions are met, for example at constant load states such as idling or driving with cruise control or as a function of the operational state of the internal combustion engine. Furthermore, as an alternative or in addition thereto it may be provided that the method is started manually, for example for inspection purposes.

In a first method step 31 it is checked whether specific starting conditions for a test run are met. The starting conditions are preferably an active internal combustion engine, an active combustion control, in the exemplary embodiment in particular an active lambda control. The test run is only started and thus carried out when the starting conditions are met, in this case when the internal combustion engine and the combustion control are active. It is advantageous if a constant load is present. However, it is sufficient if any load is present. In this case it is irrelevant whether this is for example idling or an increased partial load.

In a preferred embodiment load fluctuations can also be identified during the test run and taken into account or compensated for during the evaluation. For this purpose the load changes during the test run are detected and the measured values and optionally the desired values are corrected by their load fluctuation-related proportion. Currently load fluctuations of up to 20% can be compensated in this way.

Thus the test run takes place during the operation of the internal combustion engine, during an active combustion control, preferably at constant load, such as for example when idling or driving with cruise control. In principle, additionally or alternatively also other starting conditions, such as for example a specific engine temperature, can also be predetermined. Thus it is possible to carry out the measurement at typical operating points on the internal combustion engine. This improves the sensor precision in this region.

If all starting conditions are met, the test run in which the fuel pressure sensor 10 is tested is started automatically in a second method step 32.

In a third method step 33, in the test run an initial measured value of a measurement variable dependent upon the working pressure, for example an initial fuel injection duration, is determined and stored. In this case in an embodiment of the method a fuel injection duration of each individual fuel injector 24 is determined and an average value is created therefrom. Thus the initial fuel injection duration is formed as the average value of the individual fuel injection durations. The initial fuel injection duration is a fuel injection duration which is set currently in operation and therefore when the third method step 33 is carried out. The fuel pressure sensor 10 is tested with respect to all cylinders 22 by the formation of the average value from the individual fuel injection durations of the fuel injectors 24. In principle the initial fuel injection duration 17 can be provided as a fuel injection duration of one of the fuel injectors 24 or as an average value of a specific number of the fuel injectors 24, for example one cylinder bank. In this way the fuel pressure sensor 10 can be tested with respect to one individual cylinder 22 and therefore individual cylinders or a cylinder bank can be tested.

In an alternative embodiment the initial fuel injection duration 17 is formed as a total injection duration of the individual fuel injection durations rather than as an average value. In this case although the entire evaluation takes place on a different level, when considered in percentage terms the result is the same.

Then in the test run in a fourth method step 34 a fuel pressure jump is performed in which the fuel pressure in the high pressure system 23 is changed from a working pressure value 12 to a test pressure value 14, so that the fuel injection duration is changed. The fuel pressure jump is performed during the operation of the internal combustion engine and active combustion control. In this case the working pressure value 12 of the fuel pressure in the high pressure system 23, based on the fuel pressure jump performed, is in the region of a pressure range for which the high pressure system 23 is provided. In this exemplary embodiment the working pressure value 12 is between 150 and 200 bars. Thus the test run is carried out at high fuel pressures. If the fuel pressure for performing the fuel pressure jump is reduced, the fuel injection duration required in order to deliver the same fuel mass is increased. If the fuel pressure for performing the fuel pressure jump is increased, the fuel injection duration required in order to deliver the same fuel mass is reduced. In this exemplary embodiment the fuel pressure is reduced from the working pressure value 12 to the test pressure value 14. Thus the working pressure value 12 is higher than the test pressure value 14, so that the fuel injection duration is increased. In principle the fuel pressure for the change can also be increased.

In a fifth method step 35 there is a delay for a specific adjustment time, so that the test pressure value 14 settles. This adjustment time is typically stored in the control and regulating unit 21. The adjustment time is preferably selectable.

After the adjustment time has elapsed, and thus after the change of the fuel pressure, an actual value of the measurement variable, which in the exemplary embodiment is configured as an actual fuel injection duration 16, is determined in the test run in a sixth method step 36. In this case the actual fuel injection duration 16 is determined as a function of a combustion control which in the illustrated embodiment is implemented as a lambda control. The actual fuel injection duration 16 is predetermined or set by the lambda control in order to inject the necessary fuel mass. If the engine load is unchanged, the necessary fuel mass also remains the same. The fuel pressure jump is compensated for by the lambda control which adapts the fuel injection duration to the test pressure value 14. The adapted fuel injection duration is designated as the actual fuel injection duration 16. If the fuel pressure sensor 10 is defective and thus measures an incorrect fuel pressure, the lambda control corrects the fuel injection duration. This fuel injection duration which is corrected by the lambda control forms the actual fuel injection duration 16. Thus the actual fuel injection duration 16 forms a new effective fuel injection duration after the pressure jump.

After the change of the fuel pressure, in the sixth method step 36 a desired value of the measurement variable, which in the exemplary embodiment is configured as a desired fuel injection duration 15, can be assigned. In this case the desired value can be, for example, stored in a table from which a characteristic field can be taken or calculated. For example, after the pressure jump, starting from the initial fuel injection duration 17 before the pressure jump and the magnitude of the pressure jump, the desired fuel injection duration is assigned. The desired fuel injection duration 15 can be determined as a function of the fuel pressure which is detected by the fuel pressure sensor 10. Thus the desired fuel injection duration 15 forms an expected fuel injection duration which results from the measured fuel pressure and is dependent upon the predetermined value of the combustion control, i.e. the lambda value in the case of a lambda control. In the case of a lambda control, with a specific drawn-in air mass which is measured by the air mass measuring device, an associated required fuel mass is produced which must be injected in order to maintain or to set the required lambda value, for example the lambda value 1 in homogeneous operation. With the aid of this required fuel mass and the fuel pressure measured by the fuel pressure sensor 10 and prevailing after the change a corresponding fuel injection duration is determined. This fuel injection duration determined with the aid of the fuel pressure sensor 10 forms the desired fuel injection duration 15.

As an alternative to the actual fuel injection duration 16 and desired fuel injection duration 15, in the sixth method step 36 a desired difference 18 between the initial fuel injection duration 17 and the desired fuel injection duration 15 and an actual difference 19 between the initial fuel injection duration 17 and the actual fuel injection duration 16 are determined.

If the desired values are stored as percentages in a table, a characteristic field or the like, it is possible to dispense with the determination of the absolute desired values and the recalculation thereof in percentages of the desired value.

For evaluation, in the test run in the seventh method step 37 the actual fuel injection duration 16 can be compared with the desired fuel injection duration 15, or the desired difference 18 can be compared with the actual difference 19, and the deviation 20 can be determined. If this deviation 20 exerts a predeterminable, variably definable tolerance value, it is concluded that a measurement of the fuel pressure is incorrect.

In a particularly advantageous configuration the determination of the deviation of the fuel injection duration takes place independently of the load. For this purpose a percentage value for the actual fuel injection duration 16 is determined from the actual fuel injection duration 16 and is compared with an associated percentage value for the desired fuel injection duration 15 formed from the desired fuel injection duration 15 or taken from a table or a characteristic field. For consideration in percentage terms, in the method step 37 a percentage value for the initial fuel injection duration 17 of 100 (for example 0.4 ms=100%) is associated with the initial fuel injection duration 17 before the pressure jump. The percentage value for the actual fuel injection duration 16 after the pressure jump is set in relationship with this (for example: 0.68 ms=170%). Likewise the percentage value for the desired fuel injection duration 15 is set in relationship with the percentage value for the initial fuel injection duration 17 (e.g. 0.6 ms=150%). Then the percentage value for the actual fuel injection duration 16 and the percentage value for the desired fuel injection duration 15 are compared with one another in order to determine a percentage value for the deviation 20. In the present example a percentage value for the deviation 20 of 20 [%] is produced here.

Alternatively, a percentage value for the desired difference 18 between the initial fuel injection duration 17 and the desired fuel injection duration 15 and a percentage value for the actual difference 19 between the initial fuel injection duration 17 and the actual fuel injection duration 16 can also be determined. Then the percentage value for the actual actual difference 19 (in the example 0.28 ms=70%) and the percentage value for the desired difference 18 (in the example 0.2 ms=50%) are compared with one another in order to determine the percentage value for the deviation 20. The percentage value for the desired difference 18 is only dependent upon the pressure jump and the level at which the pressure jump is performed. Since in a diagnostic operation both values are known, in an embodiment the percentage value for the desired difference 18 can also be stored as a characteristic value or characteristic curve for pressure jump or as a characteristic field for pressure jump and pressure level in the engine control unit as a data set. In this case it is advantageous that these values do not have to be recalculated for every diagnosis. Here too in the present example a percentage value of 20 is produced for the deviation 20.

If the percentage value for the deviation 20 is greater than a predeterminable, variably definable tolerance, it is concluded that a measurement of the fuel pressure is incorrect. By the conversion into percentage values the results at constant load are independent of the magnitude of the applied load. Thus the test run can be started and carried out at any working pressure values and any loads.

In a favorable embodiment of the method the test procedure can also be carried out under a fluctuating load. In particular load fluctuations can also be identified during the test run and taken into account or compensated for during the evaluation. For this purpose the load changes during the test run are detected and the measured values and desired values are corrected by their load fluctuation-related proportion. Currently load fluctuations of up to 20% can already be compensated for in this way.

In an eighth method step 38 the deviation 20 or the percentage value for the deviation 20 is compared with a predeterminable tolerance. The tolerance can be provided as a percentage tolerance. The tolerance is typically dependent upon the working pressure value 12 and the magnitude of the change of the fuel pressure. It is preferably stored in the control and regulating unit 21. If the load-independent percentage value for the deviation 20 is less than or equal to the tolerance, a fault-free fuel pressure sensor 10 is recognised, so that according to the method step 38 the method is ended. If the percentage value for the deviation 20 is greater than the tolerance, a defective fuel pressure sensor 10 is recognised, so that a further method step 39 is carried out.

If during the test run the load changes beyond a definable load fluctuation limit, for example due to considerable acceleration, in an embodiment of the method the test run is ended without a result. The test run starts again when the starting conditions are met.

In principle in an alternative embodiment envisaged it may be provided that during the test run the change of the load is actively prevented, for example by the control and regulating unit 21.

In the ninth method step 39 a correction run of the fuel pressure sensor 10 is carried out according to the deviation 20. The ninth method step 39 and thus the correction run is only carried out if a fault is identified by the test run. If no fault is identified the method is ended.

In a tenth method step 40, whether the correction and thus the correction run were successful is tested. If the correction was successful the method is ended. If the correction fails, an eleventh method step 41 is carried out.

In an alternative embodiment, if the correction fails the method step 39 is repeated. In this case, the number of correction attempts is preferably detected and an eleventh method step 41 is carried out if a definable number of correction attempts fails.

In the eleventh method step 41 an error bit is set. The error bit is only set when the correction fails. At the same time a display signal is generated, so that a driver is made aware of the fault, for example by means of an indicator light in the vehicle interior, and for example is prompted to find a garage.

In a twelfth method step 42 a distinction is made between a tolerable and a detrimental fault, in particular with regard to optimal combustion. The identified fault of the fuel pressure sensor 10 is examined for relevance to the exhaust gas. If a fault relevant to the exhaust gas is identified, this is displayed and, for example, an indicator light lights up. After the twelfth method step 42 the method is ended. After the ending of the method the working pressure value 12 is reset. Alternatively the working pressure value 12 can also be reset after the end of the test run.

Alternatively the correction run and thus the method steps 39, 40 can be omitted, so that an error bit is set after the identification of a fault without a correction attempt. Furthermore, it is conceivable in principle that after a fault is identified an error bit is not set until the fault is repeated. Furthermore it is conceivable in principle that after a fault is identified a second test run is carried out, wherein a fuel pressure jump for example to another pressure level or from another pressure level is performed in the second test run. Then a correction attempt can be carried out and/or an error bit can be set with or without a repetition of the fault. Moreover it is conceivable that the desired fuel injection duration 15 and the actual fuel injection duration 16 or the percentage values thereof are continuously compared with one another, so that the fault can be identified particularly quickly. Alternatively, the desired difference 18 and the actual difference 19 or the percentage values thereof can be used.

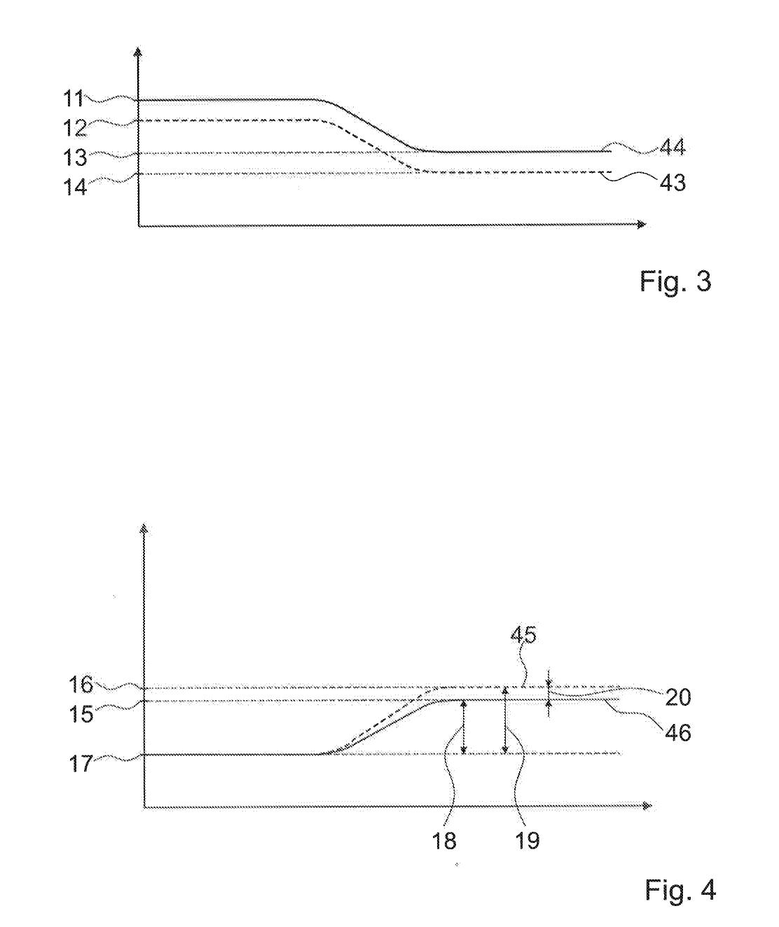

FIGS. 3 and 4 show an example of a change of the fuel pressure in the test run in a defective fuel pressure sensor 10. In this case FIG. 3 shows an effective actual fuel pressure curve 43 and an expected desired fuel pressure curve 44. FIG. 4 shows an actual fuel injection duration curve 45 associated with the actual fuel pressure curve 43 and an expected desired fuel injection duration curve 46 associated with the desired fuel injection duration curve 44. In the selected unscaled representation this also corresponds to a representation in percentage terms of an actual fuel injection duration curve 45 and of a desired fuel injection duration curve 46.

In the illustrated example the fuel pressure sensor 10 measures an incorrect fuel pressure on the basis of an offset error. As can be seen from FIG. 3, the fuel pressure sensor 10 measures an excessively high fuel pressure, so that the expected fuel pressure is higher than the effective fuel pressure. As a result the working pressure value 11 measured by the fuel pressure sensor 10 differs from the effective working pressure value 12 and the test pressure value 13 measured by the fuel pressure sensor 10 differs from the effective test pressure value 14.

The test run is carried out in order to identify such a fault. In the test run the fuel pressure is changed in the high pressure system 23 from the working pressure value 11, 12 to the test pressure value 13, 14. In this exemplary embodiment the fuel pressure is changed to a low pressure level, so that the fuel pressure is reduced from the working pressure value 11, 12 to the test pressure value 13, 14. Due to the change of the fuel pressure the fuel injection duration changes, in order to inject the fuel mass which remains constant due to constant load. In this case the fuel injection duration increases, since the fuel pressure is reduced. Since the effective fuel pressure is lower than the expected fuel pressure, the effective actual fuel injection duration 16 is greater than the expected desired fuel injection duration 15. Thus the actual difference 19 between the initial fuel injection duration 17 and the actual fuel injection duration 16 is greater than the desired difference 18 between the initial fuel injection duration 17 and the desired fuel injection duration 20, so that the actual difference 19 and the desired difference 18 differ from one another in the magnitude of the deviation 20. Between the change of the fuel pressure and the change of the fuel injection duration there is a non-linear correlation, so that the deviation between the actual difference 19 and the desired difference 18 increases with the fuel pressure jump. In a fault-free fuel pressure sensor 10 the actual fuel pressure curve and the desired fuel pressure curve as well as the actual fuel injection duration curve and the desired fuel injection duration curve coincide or lie within the tolerance which forms a tolerance range.

If the fuel pressure sensor 10 for example has an offset error of +20 bars and the effective fuel pressure has an actual working pressure value 12 of 180 bars, the fuel pressure sensor 10 would measure a desired working pressure value 11 of 200 bars. If for the change the fuel pressure is reduced by 50 bars, an actual test pressure 14 of 130 bars is set. However, the fuel pressure sensor 10 measures a desired test pressure value 13 of 150 bars. Thus a fuel pressure jump from 200 to 150 bars is expected, and a fuel pressure jump from 180 to 130 bars actually takes place. Thus the fuel injection duration would be longer than expected, so that the offset error is identified.

In order to identify a fault, in particular an offset error, the percentage value for the actual difference 19 is preferably compared with the percentage value for the desired difference 18, wherein the percentage value for the initial fuel injection duration 17 is set to 100.

For example, a percentage value of 100 is associated with an initial fuel injection duration 17 of 0.4 ms. The actual fuel injection duration 16 after the pressure jump of for example 0.68 ms is set in relationship in percentage terms with this, in this case 0.68 ms=170%. Thus the actual fuel injection duration 16 has increased by comparison with the initial fuel injection duration 17 by 70%. Likewise the desired fuel injection duration 15 is set in relationship in percentage terms with the initial fuel injection duration 17 (e.g. 0.6 ms=150%), which means that the injection duration should increase by 50%. The percentage value for the desired difference 18 can be stored in a characteristic field of the initial data or the like.

If the percentage value for the actual difference 19 (70%) is compared with the percentage value for the desired difference 18 (50%), a percentage value for the deviation 20 of 20 [%], which in turn implies a defective pressure sensor if this value exceeds a predeterminable tolerance.

Thus for determination of a fault of a pressure sensor, before a pressure jump the initial fuel injection duration 17 in percentage terms is set to 100% (for example: 0.4 ms=100%).

The percentage value for the actual fuel injection duration 16 after the pressure jump is set in relationship with this (for example: 0.68 ms=170%). The fuel injection duration is increased by 70%. The desired fuel injection duration 15 is the fuel injection duration which would be expected after the pressure jump in the case of correct pressure measurement. The percentage value for the desired fuel injection duration 15 is increased during the pressure jump from 0.4 ms to 0.6 ms (from 100% to 150%), that is to say by only 50%. The value calculated in this way is only dependent upon p, the pressure delta and the level at which it is carried out (A=constant, raw=constant). The following applies:

$$\dot{V} = A * \sqrt{\frac{2 * p}{roh}}$$

Since the deviation 20 between the desired and actual values is known, it is possible to draw a conclusion as to the actual pressure level.

1.-10. (canceled)

11. A method for testing a fuel pressure system, including a fuel pressure sensor, of a combustion controlled internal combustion engine of a motor vehicle, comprising the steps of:
changing a fuel pressure in a test run from a working pressure value to a test pressure value while a combustion control is active, wherein an initial measured value of a measurement variable dependent upon a working pressure is detected, and after the changing of the fuel pressure to the test pressure value an actual value of the measurement variable is detected;
wherein a desired value is associated with the measurement variable, wherein the desired value, the actual value, and the initial measured value are set in relation to one another by converting the desired value, the actual value, and the initial measured value into respective percentage values, and wherein a percentage value of 100 is associated with the initial measured value; and
comparing the percentage value for the desired value to the percentage value for the actual value and identifying a fault if the percentage value for the actual value deviates from the percentage value for the desired value beyond a definable tolerance.

12. The method according to claim 11, wherein the initial measured value is an initial fuel injection duration, the actual value is an actual fuel injection duration, and the desired value is a desired fuel injection duration.

13. The method according to claim 11, wherein at least two test runs are carried out at the working pressure value and the test pressure value.

14. The method according to claim 11, wherein at least two test runs are carried out at the working pressure value and/or with different test pressure values.

15. The method according to claim 11, wherein at least two test runs are carried out with different pressure jump directions to the test pressure value.

16. The method according to claim 11, wherein load changes are detected during the test run and the test pressure value is corrected by a respective load change-related proportion and/or the desired value and the actual value are corrected by respective load change-related proportions.

17. The method according to claim 11, wherein during the changing of the fuel pressure, a second actual value is recorded and is set in relationship in percentage terms with the initial measured value as a percentage, a percentage value for a second desired value is determined and is compared with the percentage value for the second actual value and a fault is identified if the percentage value for the second actual value deviates from the percentage value for the second desired value by a definable tolerance.

18. The method according to claim 11, wherein:
the fault is only identified as a sensor fault when the fault is present irrespective of a cylinder of the internal combustion engine; and
the fault is only identified as a sensor fault if the fault is present on a plurality of banks of the internal combustion engine.

19. The method according to claim 11, wherein when the fault is identified an error bit is set as a fault reaction, fault signaling takes place and/or a fault correction takes place, wherein for the fault correction, in a correction run, the fuel pressure sensor is corrected according to a deviation between the desired value and the actual value.

10. A device for a combustion controlled internal combustion engine of a motor vehicle, comprising:
a fuel pressure sensor for recording a fuel pressure; and
a control and/or regulating unit for testing a fuel pressure system, wherein in a test run the fuel pressure is changeable by the control and/or regulating unit from a working pressure value to a test pressure value while a combustion control is active;
wherein the control and/or regulating unit, after a change of the fuel pressure, compares a percentage value for a desired value and a percentage value for an actual value and identifies a fault in the fuel pressure sensor if the percentage value for the actual value deviates from the percentage value for the desired value beyond a definable tolerance.
